(19) United States
(12) Patent Application Publication
(10) Pub. No.: US 2008/0057242 A1
(43) Pub. Date: Mar. 6, 2008

(54) Co-moulding polymers in injection stretch blow moulding

(76) Inventors: David Jasper Tai Wai Wong, Wan Chai (CN); Hiu Ping Yau, Wan Chai (CN)

Correspondence Address: MERCHANT & GOULD PC, P.O. BOX 2903, MINNEAPOLIS, MN, 55402-0903, US

(21) Appl. No.: 11/515,588

(22) Filed: Sep. 5, 2006

(51) Int. Cl. B32B 27/08; B29C 49/06; B29C 49/22

(52) U.S. Cl. 428/35.7; 264/512; 264/537

(57) ABSTRACT

A dual-texture article comprises at least two same or different polymers having same or different melt flow rates that cause co-moulding/over-moulding of the polymers upon injection stretch blow moulding. The article has at least two interlocked combined layers. A method of manufacturing the article includes providing an intermediate layer of plastics material with at least one opening therein, injection moulding an outer layer of plastics material upon the intermediate layer to form a dual-layer insert therewith, placing the dual-layer insert into a blow moulding cavity, and blow moulding a plastics pre-form in the blow moulding cavity such that a portion of the pre-form engages with the intermediate layer and wherein the plastics pre-form connects with the outer layer through said opening.

### BACKGROUND OF THE INVENTION

The present invention relates to the co-moulding of polymers in an injection stretch blow moulding process. More particularly, although not exclusively, the invention relates to a method by which an article such as a plastics drink container can be fabricated with a dual-texture finish.

Nowadays, dual-texture designs are often preferred by customers on products such as cellular phones, toys and household products such as over-moulded toothbrushes. Consumers desire a “mix-and-match” appearance such as that afforded by a combination of PP and TPE on toothbrushes and the like. Another reason to combine more than one polymer is to optimise physical properties and cost. For example COPP can replace PP where heavy duty applications are envisaged.

Methods for adopting two same or different polymers have been used for mass production purposes. Techniques such as over-moulding, gluing, ultrasonic welding or spray rubberisation have widely been used in processing methods, but have heretofore displayed numerous limitations. Moreover, previous attempts at co-moulding polymers on injection-stretch-blown articles have not been successful due to difficulties in temperature control and complexities in matching same or different polymers' physical characteristics. Furthermore, attempts to force two polymers to combine by injection or compression (over-moulding) have heretofore resulted in distortion and destruction of the polymers when over-compressed. Poor appearance and finish has resulted. For example, plastic remnants in over-moulding of the second polymer's edges and cracking of the first polymer have resulted.

### OBJECTS OF THE INVENTION

It is an object of the present invention to overcome or substantially ameliorate at least one of the above disadvantages and/or more generally to provide a method of co-moulding polymers in an injection stretch blow moulding process.

### DISCLOSURE OF THE INVENTION

There is disclosed herein a method of manufacturing a plastics article, comprising:
providing an intermediate layer of plastics material with at least one opening therein,
injection moulding an outer layer of plastics material upon the intermediate layer to form a dual-layer insert therewith,
placing the dual-layer insert into a blow moulding cavity, and
blow moulding a plastics pre-form in the blow moulding cavity such that a portion of the pre-form extends into each opening toward the outer layer.

Preferably, the material of the pre-form engages with the outer layer through each opening.

Preferably, the intermediate layer is of hard plastics material.

Preferably, the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

Preferably, the outer layer is of soft plastics material.

Preferably, the soft plastics material is selected from the group consisting of: thermoplastic elastomer (TPE); thermoplastic olefin (TPO); thermoplastic urethane (TPU); polyvinylchloride (PVC) or commonly known as vinyl; and silicon (SI).

Preferably, the plastics pre-form is of hard, high viscosity plastics material.

Preferably, the hard, high viscosity plastics material is selected from the group consisting of: polycarbonate (PC); polyethylene terephthalate (PET); acrylonitrile styrene (AS); and K-Resin.

Preferably, the outer layer includes a textured or contoured gripping surface.

Preferably, the plastics pre-form is a hollow parison for forming a bottle.

Preferably, each opening is wider adjacent to the outer layer than it as adjacent to the pre-form.

Preferably, each opening is provided with an internal step against which the material of the plastics pre-form engages to anchor the intermediate layer to the pre-form once set.

Preferably, the intermediate layer has a larger footprint than the outer layer, and during the blow moulding step, material of the pre-form extends into the step.

There is further disclosed herein a plastics article manufactured by the above-disclosed method, the article being a bottle and wherein the outer layer forms a finger grip upon an outer surface of the bottle.

Preferably, the parison forms a containment portion of the bottle and a neck of the bottle.

There is further disclosed herein a plastics article, comprising:
an intermediate layer of plastics material with at least one opening therein,
an outer layer of plastics material injection moulded upon the intermediate layer forming a dual-layer insert therewith,
a blow moulded body having a cavity within which the dual-layer insert is received and wherein the body engages with the intermediate layer and wherein the body extends toward the outer layer through said opening(s).

Preferably, the material of the body engages with the outer layer through each opening(s).

Preferably, the intermediate layer is of hard plastics material.

Preferably, the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

Preferably, the outer layer is of soft plastics material.

Preferably, the soft plastics material is selected from the group consisting of: thermoplastic elastomer (TPE); thermoplastic olefin (TPO); thermoplastic urethane (TPU); polyvinylchloride (PVC) or commonly known as vinyl; and silicon (SI).

Preferably, the body is of hard, high viscosity plastics material.

Preferably, the hard, high viscosity plastics material is selected from the group consisting of: polycarbonate (PC); polyethylene terephthalate (PET); acrylonitrile styrene (AS); and K-Resin.

Preferably, the outer layer includes a textured or contoured gripping surface.

Preferably, each opening is wider adjacent to the outer layer than it is adjacent to the body.

Preferably, each opening comprises an internal step against which the material of the body engages for anchoring the intermediate layer to the body.

There is further disclosed herein a method of manufacturing a plastics article, comprising:
providing an intermediate layer of plastics material with a peripheral step,
injection moulding an outer layer of plastics material upon the intermediate layer to form a dual-layer insert therewith in which the intermediate layer has a larger footprint than the outer layer,
placing the dual-layer insert into a blow moulding cavity, and
blow moulding a plastics pre-form in the blow moulding cavity such that a portion of the pre-form extends into the step.

Preferably, the material of the pre-form engages with the outer layer at the outer layer periphery.

Preferably, the intermediate layer is of hard plastics material.

Preferably, the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

Preferably, the outer layer is of soft plastics material.

Preferably, the soft plastics material is selected from the group consisting of: thermoplastic elastomer (TPE); thermoplastic olefin (TPO); thermoplastic urethane (TPU); polyvinylchloride (PVC) or commonly known as vinyl; and silicon (SI).

Preferably, the plastics pre-form is of hard, high viscosity plastics material.

Preferably, the hard, high viscosity plastics material is selected from the group consisting of: polycarbonate (PC); polyethylene terephthalate (PET); acrylonitrile styrene (AS); and K-Resin.

Preferably, the outer layer includes a textured or contoured gripping surface.

Preferably, the plastics pre-form is a hollow parison for forming a bottle.

Preferably, there is at least one blind opening in the intermediate layer and the material of the pre-form extends into each blind opening.

There is further disclosed herein a plastics article manufactured by the above-disclosed method, the article being a bottle and wherein the outer layer forms a finger grip upon an outer surface of the bottle.

Preferably, the parison forms a containment portion of the bottle and a neck of the bottle.

There is further disclosed herein a plastics article, comprising:
an intermediate layer of plastics material having a peripheral step,
an outer layer of plastics material injection moulded upon the intermediate layer forming a dual-layer insert therewith and in which the intermediate layer has a larger footprint than the outer layer,
a blow moulded body having a cavity within which the dual-layer insert is received and wherein the body engages with the intermediate layer and wherein the body extends into the step.

Preferably, the body engages the periphery of the outer layer.

Preferably, the intermediate layer comprises blind opening(s) into which the body extends.

Preferably, the intermediate layer is of hard plastics material.

Preferably, the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

Preferably, the outer layer is of soft plastics material.

Preferably, the soft plastics material is selected from the group consisting of: thermoplastic elastomer (TPE); thermoplastic olefin (TPO); thermoplastic urethane (TPU); polyvinylchloride (PVC) or commonly known as vinyl; and silicon (SI).

Preferably, the body is of hard, high viscosity plastics material.

Preferably, the hard, high viscosity plastics material is selected from the group consisting of: polycarbonate (PC); polyethylene terephthalate (PET); acrylonitrile styrene (AS); and K-Resin.

Preferably, the outer layer includes a textured or contoured gripping surface.

There is further disclosed herein a method of manufacturing a plastics article, comprising:
providing an intermediate layer of plastics material including at least a first material constituent,
moulding an outer layer of plastics material upon the intermediate layer to form a dual-layer insert therewith, and
moulding a plastics body made of a material the same as and/or compatible with said first material constituent against the intermediate layer such that said compatibility enables a portion of the body to bond with the intermediate layer.

Preferably, the intermediate layer comprises a mixture of two or more materials, one of which is said first material constituent.

Preferably, the intermediate layer is of hard plastics material.

Preferably, the first constituent material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

Preferably, the outer layer is of soft plastics material.

Preferably, the soft plastics material is selected from the group consisting of: thermoplastic elastomer (TPE); thermoplastic olefin (TPO); thermoplastic urethane (TPU); polyvinylchloride (PVC) or commonly known as vinyl; and silicon (SI).

Preferably, the plastics body is of hard, high viscosity plastics material suitable for blow moulding.

Preferably, the hard, high viscosity plastics material is selected from the group consisting of: polycarbonate (PC); polyethylene terephthalate (PET); acrylonitrile styrene (AS); and K-Resin.

Preferably, the outer layer includes a textured or contoured gripping surface.

Preferably, the plastics body is blow moulded from a pre-formed hollow parison.

There is further disclosed herein a plastics article manufactured by the above-disclosed method, the article being a vessel and wherein the outer layer forms a finger grip upon an outer surface of the vessel.

There is further disclosed herein a plastics article, comprising:
an intermediate layer of plastics material including at least a first material constituent,
an outer layer of plastics material injection moulded upon the intermediate layer forming a dual-layer insert therewith, and
a moulded body made of a material the same as and/or compatible with said first material constituent and having a cavity within which the dual-layer insert is received and wherein the body is bonded with the intermediate layer.

Preferably, the intermediate layer comprises a mixture of two or more materials, one of which is said first material constituent.

Preferably, the intermediate layer is of hard plastics material.

Preferably, the first constituent material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

Preferably, the outer layer is of soft plastics material.

Preferably, the soft plastics material is selected from the group consisting of: thermoplastic elastomer (TPE); thermoplastic olefin (TPO); thermoplastic urethane (TPU); polyvinylchloride (PVC) or commonly known as vinyl; and silicon (SI).

Preferably, the body is of hard, high viscosity plastics material suitable for blow moulding.

Preferably, the hard, high viscosity plastics material is selected from the group consisting of: polycarbonate (PC); polyethylene terephthalate (PET); acrylonitrile styrene (AS); and K-Resin.

Preferably, wherein the outer layer includes a textured or contoured gripping surface.

Preferably, the body is bonded with the intermediate layer with glue.

In broad terms, the present invention precisely positions the blow moulded components with a plastics centrepiece (intermediate layer) interlock features enabling the second polymer to precisely encapsulate onto the first polymer or vice versa forming a co-moulded article with a dual-texture appearance. The second layer can be combined with more than one single layer. Layers of soft plastics (hardness typically less than 80 degrees) can be moulded together. The use of pre-formed tubes contributes to speedy production as compared to the inefficiencies of injection or over-moulding processes. The present technique will significantly reduce the risk of cracking and the formation of plastics remnants on edges. This enables a broader scope of design options for the first polymer layer. For example, smaller openings can be used such as in the necks of bottles, rather than larger openings which are a limitation of injection moulding processes where a metal tube is positioned inside the article to prevent deviation or cracking of the first layer during the injection of the second layer onto the first layer in which the diameter of the metal tube limits the size of the opening.

The present invention will diminish manufacturing costs and provide improved mass-produced items such as the outer shells of mobile phones with dual, triple or even quadruple co-moulded textures. Even very hard plastics can be co-moulded together with very soft plastics by use of the present intermediate interlock layer. For example, a durable polycarbonate and TPE co-moulded sports bottle can easily be formed.

Hard plastics such as polycarbonate, nylon, acrylic, AS etc having a hardness index greater than 80 at an ambient temperature of 20° C. or above can be used for the first layer and the intermediate interlock layer. Soft plastics typically with a hardness less than 80 such as TPE, TPO, TPU and silicon for example having soft physical properties can be used for the outer/third layer. Both the first and intermediate layers can be made independently of one another prior to the final blow moulding process.

### BRIEF DESCRIPTION OF THE DRAWINGS

Preferred forms of the present invention will now be described by way of example with reference to the accompanying drawings, wherein:

FIG. 1 is a schematic parts-exploded perspective illustration of a blow moulded bottle and dual-layer insert therefor,

FIG. 2 is a schematic cross-sectional elevation of the bottle and insert of FIG. 1,

FIG. 3 is a schematic perspective cross-sectional illustration of the dual-layer insert,

FIG. 4 is a schematic cross-sectional elevation of the dual-layer insert during its injection moulding process,

FIG. 5 is a schematic plan view of an alternative dual-layer insert, and

FIG. 6 is a schematic cross-sectional illustration of the alternative insert of FIG. 5 during its injection moulding process.

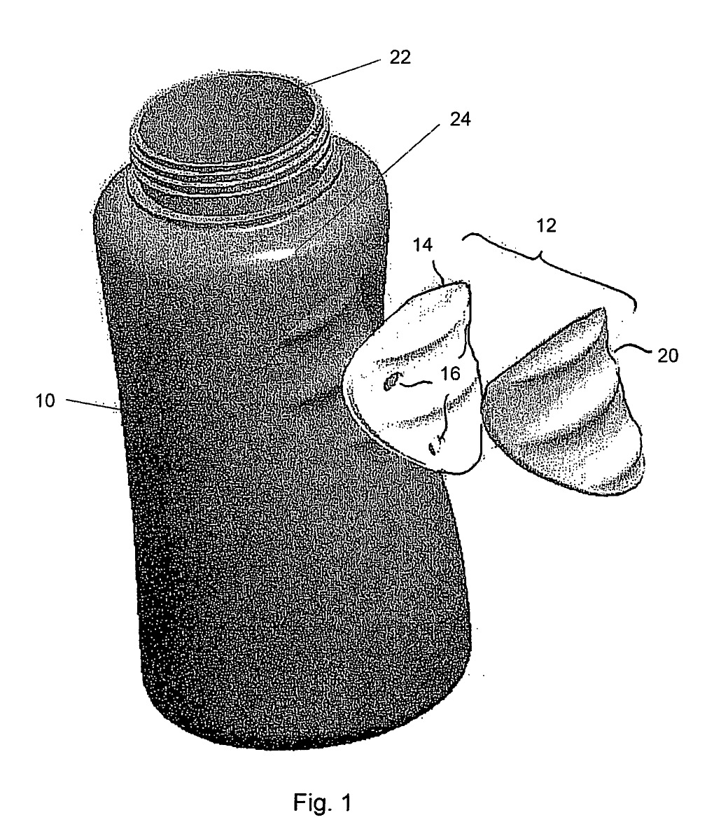

### DESCRIPTION OF THE PREFERRED EMBODIMENT

In the accompanying drawings there is depicted schematically a sports drink bottle 10 made in accordance with the invented method and in which a handgrip 12 is formed upon the bottle's exterior surface. The sports bottle has a dual-texture surface having at least two same or different polymers having the same or different melt flow rates. The bottle comprises a threaded neck 22, the diameter of which is not limited by the invented manufacturing process.

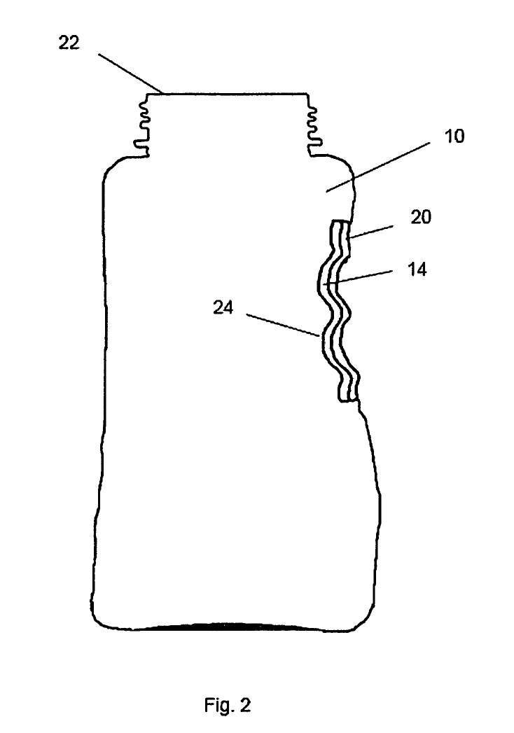

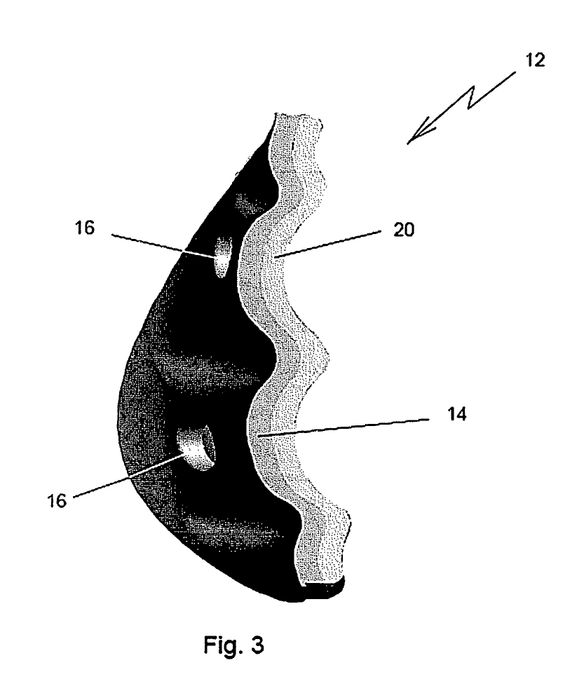

The body of the bottle 10 is pressed as a softened tubular perform or “parison” of high viscosity, high hardness material such as PC (polycarbonate), PET (polyethylene terephthalate), AS (acrylonitrile styrene), or K-Resin, by injection stretch-blow-moulding against the internal surface of a blow mould cavity in which a dual-layer handgrip 12 is pre-positioned. The stretch blow-moulding process results in the material of the bottle 10 deforming to form a recess 24 (FIG. 2) within which the dual-layer insert is permanently located.

The dual-layer insert 12 comprises an intermediate layer 14 of hard polymer such as but not limited to PC (polycarbonate), AS (acrylonitrile styrene), COPP (polypropylene copolymer), PS (polystyrene), ABS (acrylonitrile-butadiene-styrene-terpolymer), PVC (polyvinylchloride), PP (polypropylene), PE (polyethylene) or PMMA (acrylic), and an outer anti-slip layer 20 of soft plastics material such as but not limited to TPE (thermoplastic elastomer), TPR (thermoplastic resin), (TPO) thermoplastic olefin; TPU (thermoplastic urethane), or PVC (polyvinyl chloride) having good finger-grip texture in the finished article. The bottle is manufactured so as to result in permanent fixture of the dual-layer interlock insert 12 at the bottle exterior.

The second interlock layer 14 is produced separately by any process such as injection moulding, compression moulding, transfer moulding or even by hand- or machine-cutting or casting. The material for the intermediate layer 14 is selected from those materials which provide good interlocking compatibility with the material of the bottle 10 and the outer layer 20.

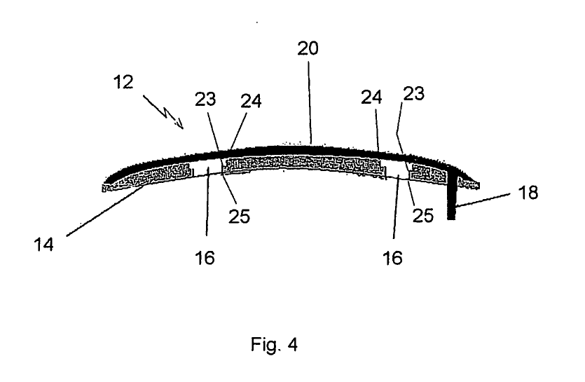

The intermediate layer 14 has a number of interlock openings in the form of apertures 16 through which material of the bottle 10 extends for anchorage to the outer layer 20 and/or through which the outer layer extends for anchorage with the bottle 10. As shown in FIG. 4, each interlock aperture is wider at 24 adjacent the outer layer than at 25—at which it will be adjacent to body of the bottle. Each aperture 16 has an annular step 23 which serves to assist anchorage of the parison material in a subsequent step.

The separately formed intermediate layer 14 with the interlocking apertures 16 already formed therein is placed into an injection moulding cavity. Plastics material is then injection moulded via a conduit 18 (FIG. 4) through the intermediate layer 14 into the first mould cavity to form the anti-slip layer 20 upon the intermediate layer 14. These layers are firmly bonded together by this process and compatibility of the chosen materials enables the two layers to meld with one another to some extent to form a permanent laminate.

The dual-layer insert 12 after setting and removal from the injection moulding cavity is then precision inserted into a blow moulding cavity after which the above-mentioned parison is injection-stretch-blow moulded to form the shape of the finished bottle whereby the softened material of the parison typically flows through the interlock apertures 16 of the intermediate layer 14 and expands behind the step 23 to anchor therewith. The parison material typically makes contact with the back of the outer finger-gripping layer 20 and contacts therewith once set.

In the process described above, the preformed tubular parison is pre-heated and caused to stretch upon the application of an airflow thereinto whilst in a softened state against the inside surface of a blow mould cavity.

The preheated parison is brought into the blow mould cavity for blowing. As a result the layers combine and interlock with a precision fit, forming an article having a dual-textured surface.

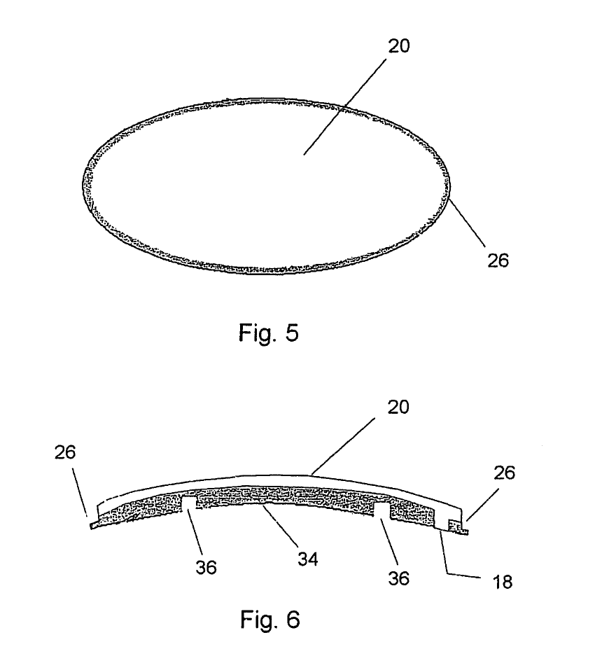

An alternative embodiment of the dual layer insert is shown in FIGS. 5 and 6. In this embodiment, the openings instead of being apertures extending the whole way through the intermediate layer 34 are provided as blind holes 36. The blind holes 36, instead of serving as an interlocking anchor, merely serve to laterally locate the intermediate layer 34 with respect to the body of the bottle. Interlocking of the intermediate layer 34 to the bottle is achieved by means of a continuous step 26 formed at the entire periphery of the intermediate layer. Moreover, the footprint of the intermediate layer 34 is slightly larger than that of the outer layer 20 by the width of the step. During the blow moulding process, a portion of the pre-form extends over and into the stepped portion 26 thereby interlocking the intermediate layer 34 to the bottle. The material of the pre-form typically extends to the periphery of the outer layer 20.

Although the described embodiments are a sports drink bottle, the process described herein could be equally applied to the manufacture of tumblers, mugs, toys, mobile phone cases, keyboards, PDAs, music players and other devices.

As an extension to the present invention, the pre-form 10 might be made of the material such as AS, PS, or ABS for example and the intermediate layer 14 would be made of the same material, or a mixture of materials including a constituent that is the same material as that from which the pre-form is made. For example, if the pre-formed 10 is of AS, the intermediate layer 14 could be AS or a combination of AS and TPR. If the pre-formed 10 is of PS, the intermediate layer 14 could be PS, or a combination of PS and TPR. If the pre-formed 10 is of ABS, the intermediate layer 14 could be ABS or a combination of ABS and TPR. The mixture of materials in the pre-form could be combined by injection. By providing the intermediate layer, or at least one constituent of the intermediate layer mixture the same as the material of the pre-form, material compatibility is achieved for the purpose of mutual adhesion without the need for providing mechanical anchoring features such as is provided by stepped openings 16 or the stepped periphery 26 of the intermediate layer as described above. Such material compatibility would enable the intermediate layer to be simply glued, fused or ultrasonically welded to the pre-form and indeed the pre-form need not be specifically blow moulded against the intermediate layer. Whilst blow moulding could remain the preferred method, in which case the heated and semi-molten nature of the pre-form during blow moulding could cause it to fuse with such a compatible-material intermediate layer, a pre-moulded bottle, tumbler, mug or other article could be made by any known technique including injection moulding and later simply fused or glued to the intermediate layer. Fusing of the materials could even result in an injection moulding technique in which the dual-layer insert is pre-located within an injection moulding cavity that defines the overall shape of the finished product.

It should be appreciated that modifications and alterations obvious to those skilled in the art are not to be considered as beyond the scope of the present invention. For example the bottle or other object made in accordance with the invention can comprise more than a single insert. A pair of finger grips could for example be provided at opposite sides of the object.

Furthermore, the invented process is not limited to hollow objects such as bottles where blow moulding is adopted, but also to flatter objects moulded by vacuum forming a pre-heated and softened a plastics sheet into an open-sided mould cavity. Also, instead of providing a distinct step 23 in each aperture, the apertures could simply widen towards the outer layer.

1. A method of manufacturing a plastics article, comprising:
providing an intermediate layer of plastics material with at least one opening therein,
injection moulding an outer layer of plastics material upon the intermediate layer to form a dual-layer insert therewith,
placing the dual-layer insert into a blow moulding cavity, and
blow moulding a plastics pre-form in the blow moulding cavity such that a portion of the pre-form extends into each opening toward the outer layer.

2. The method of claim 1, wherein the material of the pre-form engages with the outer layer through each opening.

3. The method of claim 1, wherein the intermediate layer is of hard plastics material.

4. The method of claim 3, wherein the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

5. The method of claim 1, wherein the outer layer is of soft plastics material.

6. The method of claim 5, wherein the soft plastics material is selected from the group consisting of: thermoplastic elastomer (TPE); thermoplastic olefin (TPO); thermoplastic urethane (TPU); polyvinylchloride (PVC); and silicon (SI).

7. The method of claim 1, wherein the plastics pre-form is of hard, high viscosity plastics material.

8. The method of claim 7, wherein the hard, high viscosity plastics material is selected from the group consisting of: polycarbonate (PC); polyethylene terephthalate (PET); acrylonitrile styrene (AS); and K-Resin.

9. The method of claim 1, wherein the outer layer includes a textured or contoured gripping surface.

10. The method of claim 1, wherein the plastics pre-form is a hollow parison for forming a bottle.

11. The method of claim 1, wherein each opening is wider adjacent to the outer layer than it as adjacent to the pre-form.

12. The method of claim 11, wherein each opening is provided with an internal step against which the material of the plastics pre-form engages to anchor the intermediate layer to the pre-form once set.

13. The method of claim 1, wherein the intermediate layer is stepped to thereby provide a larger footprint than the outer layer, and wherein during the blow moulding step, material of the pre-form extends into the step.

14. A plastics article manufactured by the method of claim 10, the article being a bottle and wherein the outer layer forms a finger grip upon an outer surface of the bottle.

15. The article of claim 14, wherein the parison forms a containment portion of the bottle and a neck of the bottle.

16. A plastics article, comprising:
an intermediate layer of plastics material with at least one opening therein,
an outer layer of plastics material injection moulded upon the intermediate layer forming a dual-layer insert therewith,
a blow moulded body having a cavity within which the dual-layer insert is received and wherein the body engages with the intermediate layer and wherein the body extends toward the outer layer through said opening(s).

17. The article of claim 16, wherein the material of the body engages with the outer layer through each opening(s).

18. The article of claim 16, wherein the intermediate layer is of hard plastics material.

19. The article of claim 18, wherein the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

20. The article of claim 16, wherein the outer layer is of soft plastics material.

21. The article of claim 20, wherein the soft plastics material is selected from the group consisting of: thermoplastic elastomer (TPE); thermoplastic olefin (TPO); thermoplastic urethane (TPU); polyvinylchloride (PVC); and silicon (SI).

22. The article of claim 16, wherein the body is of hard, high viscosity plastics material.

23. The article of claim 22, wherein the hard, high viscosity plastics material is selected from the group consisting of: polycarbonate (PC); polyethylene terephthalate (PET); acrylonitrile styrene (AS); and K-Resin.

24. The article of claim 16, wherein the outer layer includes a textured or contoured gripping surface.

25. The article of claim 16, wherein each opening is wider adjacent to the outer layer than it is adjacent to the body.

26. The article of claim 25, wherein each opening comprises an internal step against which the material of the body engages for anchoring the intermediate layer to the body.

27. A method of manufacturing a plastics article, comprising:
providing an intermediate layer of plastics material with a peripheral step,
injection moulding an outer layer of plastics material upon the intermediate layer to form a dual-layer insert therewith in which the intermediate layer has a larger footprint than the outer layer,
placing the dual-layer insert into a blow moulding cavity, and
blow moulding a plastics pre-form in the blow moulding cavity such that a portion of the pre-form extends into the step.

28. The method of claim 27, wherein the material of the pre-form engages with the outer layer at the outer layer periphery.

29. The method of claim 27, wherein the intermediate layer is of hard plastics material.

30. The method of claim 29, wherein the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

31. The method of claim 27, wherein the outer layer is of soft plastics material.

32. The method of claim 31, wherein the soft plastics material is selected from the group consisting of: thermoplastic elastomer (TPE); thermoplastic olefin (TPO); thermoplastic urethane (TPU); polyvinylchloride (PVC); and silicon (SI).

33. The method of claim 27, wherein the plastics pre-form is of hard, high viscosity plastics material.

34. The method of claim 33, wherein the hard, high viscosity plastics material is selected from the group consisting of: polycarbonate (PC); polyethylene terephthalate (PET); acrylonitrile styrene (AS); and K-Resin.

35. The method of claim 27, wherein the outer layer includes a textured or contoured gripping surface.

36. The method of claim 27, wherein the plastics pre-form is a hollow parison for forming a bottle.

37. The method of claim 27, further comprising at least one blind opening in the intermediate layer and wherein material of the pre-form extends into each blind opening.

38. A plastics article manufactured by the method of claim 27, the article being a bottle and wherein the outer layer forms a finger grip upon an outer surface of the bottle.

39. The article of claim 38, wherein the parison forms a containment portion of the bottle and a neck of the bottle.

40. A plastics article, comprising:
an intermediate layer of plastics material with a peripheral step,
an outer layer of plastics material injection moulded upon the intermediate layer forming a dual-layer insert therewith and in which the intermediate layer has a larger footprint than the outer layer,
a blow moulded body having a cavity within which the dual-layer insert is received and wherein the body engages with the intermediate layer and wherein the body extends into the step.

41. The plastics article of claim 40, wherein the body engages the periphery of the outer layer.

42. The article of claim 40, the intermediate layer comprises blind opening(s) into which the body extends.

43. The article of claim 40, wherein the intermediate layer is of hard plastics material.

44. The article of claim 40, wherein the hard plastics material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

45. The article of claim 40, wherein the outer layer is of soft plastics material.

46. The article of claim 45, wherein the soft plastics material is selected from the group consisting of: thermoplastic elastomer (TPE); thermoplastic olefin (TPO); thermoplastic urethane (TPU); polyvinylchloride (PVC); and silicon (SI).

47. The article of claim 40, wherein the body is of hard, high viscosity plastics material.

48. The article of claim 47, wherein the hard, high viscosity plastics material is selected from the group consisting of: polycarbonate (PC); polyethylene terephthalate (PET); acrylonitrile styrene (AS); and K-Resin.

49. The article of claim 40, wherein the outer layer includes a textured or contoured gripping surface.

50. A method of manufacturing a plastics article, comprising:
providing an intermediate layer of plastics material including at least a first material constituent,
moulding an outer layer of plastics material upon the intermediate layer to form a dual-layer insert therewith, and
moulding a plastics body of a material the same as and/or compatible with said first material constituent against the intermediate layer such that said compatibility enables a portion of the body to bond with the intermediate layer.

51. The method of claim 50, wherein the intermediate layer comprises a mixture of two or more materials, one of which is said first material constituent.

52. The method of claim 50, wherein the intermediate layer is of hard plastics material.

53. The method of claim 52, wherein the first constituent material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

54. The method of claim 50, wherein the outer layer is of soft plastics material.

55. The method of claim 54, wherein the soft plastics material is selected from the group consisting of: thermoplastic elastomer (TPE); thermoplastic olefin (TPO); thermoplastic urethane (TPU); polyvinylchloride (PVC); and silicon (SI).

56. The method of claim 50, wherein the plastics body is of hard, high viscosity plastics material suitable for blow moulding.

57. The method of claim 56, wherein the hard, high viscosity plastics material is selected from the group consisting of: polycarbonate (PC); polyethylene terephthalate (PET); acrylonitrile styrene (AS); and K-Resin.

58. The method of claim 50, wherein the outer layer includes a textured or contoured gripping surface.

59. The method of claim 50, wherein the plastics body is blow moulded from a pre-formed hollow parison.

60. A plastics article manufactured by the method of claim 50, the article being a vessel and wherein the outer layer forms a finger grip upon an outer surface of the vessel.

61. The article of claim 60, wherein the body is bonded with the intermediate layer with glue.

62. A plastics article, comprising:
an intermediate layer of plastics material including at least a first material constituent,
an outer layer of plastics material injection moulded upon the intermediate layer forming a dual-layer insert therewith, and
a moulded body made of a material the same as and/or compatible with said first material constituent and having a cavity within which the dual-layer insert is received and wherein the body is bonded with the intermediate layer.

63. The article of claim 62, wherein the intermediate layer comprises a mixture of two or more materials, one of which is said first material constituent.

64. The article of claim 62, wherein the intermediate layer is of hard plastics material.

65. The article of claim 64, wherein the first constituent material is selected from the group consisting of: polycarbonate (PC); acrylonitrile styrene (AS); polypropylene copolymer (COPP); polystyrene (PS); acrylonitrile-butadiene-styrene terpolymer (ABS); and acrylic (PMMA).

66. The article of claim 62, wherein the outer layer is of soft plastics material.

67. The article of claim 66, wherein the soft plastics material is selected from the group consisting of: thermoplastic elastomer (TPE); thermoplastic olefin (TPO); thermoplastic urethane (TPU); polyvinylchloride (PVC); and silicon (SI).

68. The article of claim 62, wherein the plastics body is of hard, high viscosity plastics material suitable for blow moulding.

69. The article of claim 68, wherein the hard, high viscosity plastics material is selected from the group consisting of: polycarbonate (PC); polyethylene terephthalate (PET); acrylonitrile styrene (AS); and K-Resin.

70. The article of claim 62, wherein the outer layer includes a textured or contoured gripping surface.

71. The article of claim 62, wherein the body is bonded with the intermediate layer with glue.
